(19) United States
(12) Patent Application Publication
(10) Pub. No.: US 2006/0118705 A1
(43) Pub. Date: Jun. 8, 2006

(54) Apparatus and method for adjusting amount of light emitted by registration sensor

(75) Inventors: Yoon-seop Eom, Suwon-si (KR); Seung-Deog An, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/283,737

(22) Filed: Nov. 22, 2005

(30) Foreign Application Priority Data
Dec. 3, 2004 (KR) 10-2004-0101156

(51) Int. Cl. H01J 40/14; G03G 15/01

(52) U.S. Cl. 250/221; 399/301; 347/116

(57) ABSTRACT

An apparatus and method are provided for adjusting the amount of light emitted by registration sensors. The apparatus comprises a first registration sensor emitting and receiving light for detecting a developed first registration pattern, a second registration sensor emitting and receiving light for detecting a developed second registration pattern, a signal converter converting a first received light signal received by the first registration sensor and a second received light signal received by the second registration sensor, a light controller outputting a first control signal in response to the converted first received light signal for adjusting an amount of a first emitted light by the first registration sensor, or a second control signal in response to the converted second received light signal for adjusting an amount of a second emitted light by the second registration sensor, a first registration sensor operator operating the first registration sensor in response to the first control signal, and a second registration sensor operator operating the second registration sensor in response to the second control signal.

### CROSS-REFERENCE TO RELATED APPLICATION

This application claims the benefit under 35 U.S.C. §119(a) of a Korean Patent Application No. 10-2004-0101156, filed on Dec. 3, 2004, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an apparatus and method for adjusting the amount of light emitted by registration sensors for determining an arrangement of images in an image forming apparatus.

2. Description of the Related Art

An image forming apparatus contains registration sensors on both sides thereof. A registration sensor is a device for determining whether an error occurs in an arrangement of images by scanning light on registration patterns developed on a transfer roller and detecting reflected light. The amount of light emitted by the registration sensors must be constant to detect the error in an arrangement of registration patterns. The registration sensors comprise a light emitter (not shown) and a light receiver (not shown) for emitting and receiving light. Conventionally, one control signal adjusts the amount of light emitted by the registration sensors or the light receiver of the registration sensors adjusts the amount of light received.

However, since the amount of light emitted or received by the registration sensors varies, it is not possible to detect the error in the arrangement of registration patterns on both sides of the image forming apparatus. It causes manufacturing errors of an optical lens, and installation errors of the registration sensors installed on both sides of a transfer belt. Therefore, since it is not possible to independently control the amount of light emitted by the registration sensors, the amount of light emitted by the registration sensors cannot be properly adjusted.

Accordingly, a need exists for a method and apparatus for adjusting the amount of light emitted by registration sensors to detect errors in image forming apparatus.

### SUMMARY OF THE INVENTION

An aspect of the present invention is to provide an apparatus for adjusting the amount of light emitted by registration sensors.

Another aspect of the present invention is also to provide a method of adjusting the amount of light emitted by registration sensors.

According to an aspect of the present invention, an apparatus is provided for adjusting the amount of light emitted by registration sensors. The apparatus comprises a first registration sensor for emitting and receiving light for detecting a developed first registration pattern, a second registration sensor for emitting and receiving light for detecting a developed second registration pattern, a signal converter for converting a first received light signal received by the first registration sensor and a second received light signal received by the second registration sensor, a light controller for outputting a first control signal in response to the converted first received light signal for adjusting an amount of a first emitted light by the first registration sensor, or a second control signal in response to the converted second received light signal for adjusting an amount of a second emitted light by the second registration sensor, a first registration sensor operator for operating the first registration sensor in response to the first control signal, and a second registration sensor operator for operating the second registration sensor in response to the second control signal.

According to an aspect of the present invention, a method is provided for adjusting the amount of light emitted by registration sensors. The method comprises emitting and receiving light by a first registration sensor or a second registration sensor, converting a first received light signal received by the first registration sensor or a second received light signal received by the second registration sensor, outputting a first control signal for adjusting an amount of a first emitted light from the first registration sensor, or a second control signal for adjusting an amount of a second emitted light from the second registration sensor, and operating the first registration sensor in response to the first control signal or the second registration sensor in response to the second control signal.

### BRIEF DESCRIPTION OF THE DRAWINGS

The above exemplary objective and advantages of the present invention will become more apparent by describing in greater detail exemplary embodiments thereof with reference to the accompanying drawings in which:

FIG. 1 is a block diagram illustrating an apparatus for adjusting the amount of light emitted by registration sensors according to an exemplary embodiment of the present invention;

FIG. 2 is a block diagram illustrating a signal converter shown in FIG. 1;

FIG. 3 is a graph illustrating the amount of light emitted by registration sensors in response to a pulse width modulation (PWM) signal applied from a light controller shown in FIG. 1;

FIG. 4 is a block diagram illustrating a registration location detector shown in FIG. 1;

FIG. 5 is a flowchart illustrating a method of adjusting the amount of light emitted by registration sensors; and

FIG. 6 is a flowchart illustrating step 402 shown in FIG. 5.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will now be described in detail with reference to the accompanying drawings.

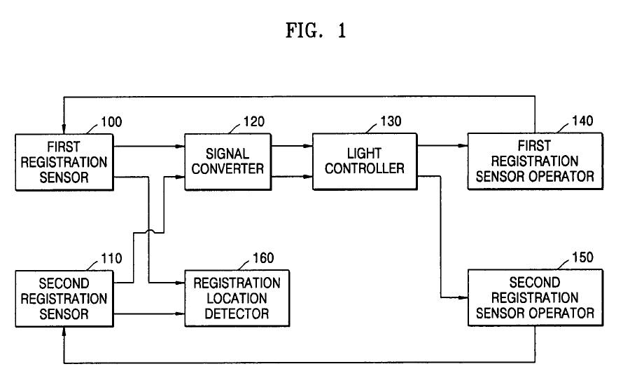

FIG. 1 is a block diagram illustrating an apparatus for adjusting the amount of light emitted by registration sensors according to an exemplary embodiment of the present invention. Referring to FIG. 1, the apparatus comprises a first registration sensor 100, a second registration sensor 110, a signal converter 120, a light controller 130, a first registration sensor operator 140, a second registration sensor operator 150, and a registration location detector 160.

The first registration sensor 100 emits and receives light for detecting a developed first registration pattern, and outputs the received and emitted light to the signal converter 120 and the registration location detector 160 as a first received light signal. The first registration pattern may be a line or a geometrical graphic. The first registration sensor 100 comprises a light emitter (not shown) and a light receiver (not shown). The light receiver comprises a photo transistor for detecting light.

Light emitted by the light emitter of the first registration sensor 100 is reflected in a transfer belt on which the first registration pattern is transferred and the light receiver receives the reflected light, thereby detecting the first registration pattern.

The second registration sensor 110 emits and receives light for detecting a developed second registration pattern, and outputs the received and emitted light to the signal converter 120 and the registration location detector 160 as a second received light signal. The second registration pattern also may be the line or the geometrical graphic. The second registration sensor 110 comprises a light emitter (not shown) and a light receiver (not shown). The light emitted by the light emitter of the second registration sensor 110 is reflected in the transfer belt on which the second registration pattern is transferred and the light receiver receives the reflected light, thereby detecting the second registration pattern.

The signal converter 120 converts the first received light signal received by the first registration sensor 100 and the second received light signal received by the second registration sensor 110, and outputs the converted signals to the light controller 130. The first received light signal and the second received light signal are signals for indicating the amount of received light as a voltage. The signal converter 120 converts the first received light signal and the second received light signal into signals received by the light controller 130.

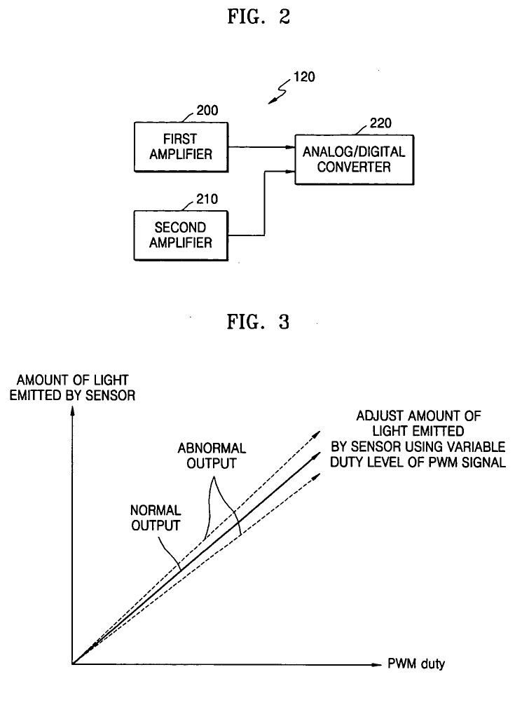

FIG. 2 is a block diagram illustrating the signal converter 120 shown in FIG. 1. Referring to FIG. 2, the signal converter 120 comprises a first amplifier 200, a second amplifier 210, and an analog/digital converter 220.

The first amplifier 200 amplifies a first received light signal and outputs the result of amplifying the signal to the analog/digital converter 220.

The second amplifier 210 amplifies a second received light signal and outputs the result of amplifying the signal to the analog/digital converter 220.

The analog/digital converter 220 converts the amplified first received light signal and the amplified second received light signal into digital signals. The analog/digital converter 220 receives the first received light signal amplified by the first amplifier 200, converts the first received light signal which is an analog signal into a digital signal, and outputs the result of converting the signal into the digital signal to the light controller 130. The analog/digital converter 220 receives the second received light signal amplified by the second amplifier 210, converts the second received light signal which is the analog signal into the digital signal, and outputs the result of converting the signal into the digital signal to the light controller 130.

The light controller 130 outputs a first control signal for adjusting the amount of a first emitted light in response to the first received light signal, or a second control signal for adjusting the amount of a second emitted light in response to the second received light signal. The first emitted light is light emitted by the first registration sensor 100, and the second emitted light is light emitted by the second registration sensor 110.

The light controller 130 outputs the first control signal to the first registration sensor operator 140 in response to the first received light signal converted by the signal converter 120. The light controller 130 outputs the second control signal to the second registration sensor operator 150 in response to the second received light signal converted by the signal converter 120.

The light controller 130 independently outputs the first control signal and the second control signal in response to the first received light signal and the second received light signal, respectively. That is, the emitted light controller 130 independently controls the first registration sensor operator 140 and the second registration sensor operator 150.

The light controller 130 outputs the first control signal for emitting the first registration sensor 100 or the second control signal for emitting the second registration sensor 110 in order to correspond to a standard amount of emitted light. The standard amount of emitted light is based on light emitted by the first registration sensor 100 and the second registration sensor 110. The light emitted by the first registration sensor 100 and the second registration sensor 110 must maintain the standard amount of emitted light so that the first registration sensor 100 and the second registration sensor 110 can accurately detect the first registration pattern and the second registration pattern. Therefore, the light controller 130 outputs the first control signal and the second control signal so that the first registration sensor 100 and the second registration sensor 110 can emit the standard amount of emitted light.

The light controller 130 outputs pulse width modulation (PWM) signals having a variable duty level as the first control signal and the second control signal. A PWM signal varies the duty level of pulse signals in order to adjust a control signal. The duty level of PWM signals corresponding to the first control signal and the second control signal must be variable in order to adjust the amount of light emitted by the first registration sensor 100 and the second registration sensor 110.

The first registration sensor operator 140 operates the first registration sensor 100 in response to the first control signal. The first registration sensor operator 140 receives the first control signal corresponding to the PWM signal having the variable duty level, and generates an analog output voltage according to the duty level. The first registration sensor operator 140 outputs the generated analog output voltage to the first registration sensor 100 as a first operation signal for operating the first registration sensor 100. The first registration sensor 100 emits light corresponding to the first operation signal in response to the received first operation signal.

The second registration sensor operator 150 operates the second registration sensor 110 in response to the second control signal. The second registration sensor operator 150 receives the second control signal corresponding to the PWM signal having the variable duty level, and generates the analog output voltage according to the duty level. The second registration sensor operator 150 outputs the generated analog output voltage to the second registration sensor 110 as a second operation signal for operating the second registration sensor 110. The second registration sensor 110 emits light corresponding to the second operation signal in response to the received second operation signal.

FIG. 3 is a graph illustrating the amount of light emitted by registration sensors in response to PWM signals of the light controller 130 shown in FIG. 1. Referring to FIG. 3, when the amount of light emitted by the first registration sensor 100 and the second registration sensor 110 is greater than or less than the standard amount of emitted light, the light controller 130 varies the duty level of the first control signal and the second control signal corresponding to PWM signals and controls the amount of light emitted by the first registration sensor 100 and the second registration sensor 110 to be equal to the standard amount of emitted light.

The registration location detector 160 detects a location of the first registration pattern in response to the first received light signal detected by the first registration sensor 100. The registration location detector 160 detects a location of the second registration pattern in response to the second received light signal detected by the second registration sensor 110.

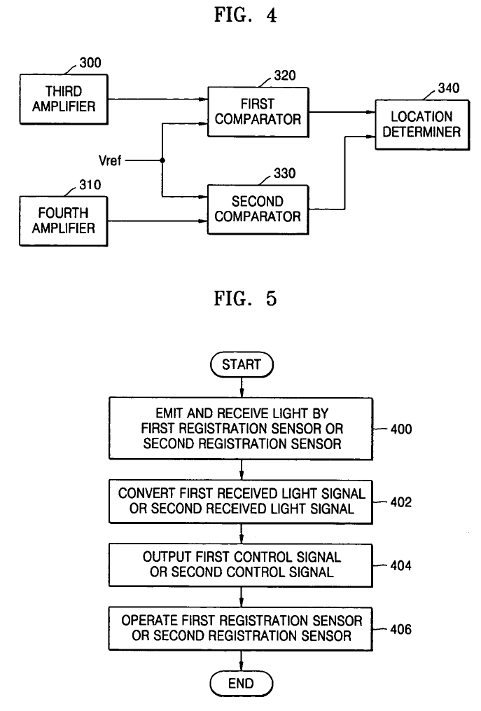

FIG. 4 is a block diagram illustrating the registration location detector 160 shown in FIG. 1. Referring to FIG. 4, the registration location detector 160 comprises a third amplifier 300, a fourth amplifier 310, a first comparator 320, a second comparator 330, and a location determiner 340.

The third amplifier 300 amplifies the first received light signal and outputs the amplified signal to the first comparator 320.

The fourth amplifier 310 amplifies the second received light signal and outputs the amplified signal to the second comparator 330.

The first comparator 320 compares the first received light signal amplified in the third amplifier 300 with a standard signal V_{ref}, and outputs a comparison signal to the location determiner 340 as a first comparison signal.

The second comparator 330 compares the second received light signal amplified in the fourth amplifier 310 with the standard signal V_{ref}, and outputs a comparison signal to the location determiner 340 as a second comparison signal.

The location determiner 340 determines locations of the first registration pattern and the second registration pattern by using the received first comparison signal and the second comparison signal.

FIG. 5 is a flowchart illustrating a method of adjusting the amount of light emitted by registration sensors. Referring to FIG. 5, the first registration sensor 100 or the second registration sensor 110 emits and receives light in step 400.

The first received light signal emitted by the first registration sensor 100 or the second received light signal emitted by the second registration sensor 110 is converted in step 402.

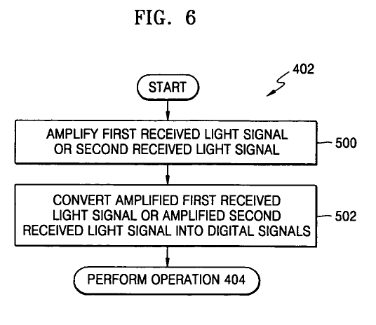

FIG. 6 is a flowchart illustrating step 402 shown in FIG. 5. Referring to FIG. 6, the first received light signal or the second received light signal is amplified in step 500.

The amplified first received light signal or the amplified second received light signal is converted into a digital signal in step 502.

The first control signal for adjusting the amount of the first emitted light by the first registration sensor 100 or the second control signal for adjusting the amount of the second emitted light from the second registration sensor 110 is output in step 404.

In step 404, the first control signal for emitting the first registration sensor 100 or the second control signal for emitting the second registration sensor 110 is output in order to make the amount of emitted light equal to the standard amount of emitted light. The first control signal or the second control signal is the PWM signal having the variable duty level.

The first registration sensor 100 is operated in response to the first control signal or the second registration sensor 110 is operated in response to the second control signal in step 406.

In step 406, the first control signal corresponds to the PWM signals having the variable duty level is received, the analog output voltage is generated according to the duty level, and the generated analog output voltage is output as the first operation signal for operating the first registration sensor 100.

In step 406, the second control signal corresponds to the PWM signals having the variable duty level is received, the analog output voltage is generated according to the duty level, and the generated analog output voltage is output as the second operation signal for operating the second registration sensor 10.

The method of adjusting the amount of light emitted by registration sensors according to an exemplary embodiment of the present invention may operate the first registration sensor 100 or the second registration sensor 110 according to the first received light signal or the second received light signal reflected from a transfer belt that is moving or not.

The apparatus and method of adjusting the amount of light emitted by registration sensors according to an exemplary embodiment of the present invention make it possible to independently adjust deviations in the amount of light emitted by registration sensors on both sides of an image forming apparatus, thereby maintaining constant the amount of light emitted by registration sensors.

The apparatus and method of adjusting the amount of light emitted by registration sensors according to an exemplary embodiment of the present invention make it possible to adjust the amount of light emitted by registration sensors by using the duty level of a PWM signal, thereby adjusting the amount of light emitted by registration sensors regardless of noise.

While the exemplary embodiments of the present invention has been particularly shown and described, it will be understood by those of ordinary skill in the art that various changes in form and details may be made therein without departing from the spirit and scope of the present invention as defined by the following claims.

What is claimed is:

1. An apparatus for adjusting an amount of light emitted by registration sensors, the apparatus comprising:
a first registration sensor for emitting and receiving light for detecting a developed first registration pattern;
a second registration sensor for emitting and receiving light for detecting a developed second registration pattern;
a signal converter for converting a first received light signal received by the first registration sensor and a second received light signal received by the second registration sensor;
a light controller for outputting at least one of a first control signal in response to the converted first received light signal for adjusting an amount of a first emitted light by the first registration sensor and a second control signal in response to the converted second received light signal for adjusting an amount of a second emitted light by the second registration sensor;
a first registration sensor operator for operating the first registration sensor in response to the first control signal; and
a second registration sensor operator for operating the second registration sensor in response to the second control signal.

2. The apparatus according to claim 1, wherein the signal converter comprises:
a first amplifier for amplifying the first received light signal;
a second amplifier for amplifying the second received light signal; and
an analog/digital converter for converting the amplified first received light signal and the amplified second received light signal into digital signals.

3. The apparatus according to claim 1, wherein the light controller outputs at least one of the first control signal and the second control signal for at least one of the amount of the first emitted light and the amount of the second emitted light to correspond to a standard emitted light.

4. The apparatus according to claim 1, wherein the light controller outputs pulse width modulation (PWM) signals comprising a variable duty level as the first control signal and the second control signal.

5. The apparatus according to claim 4, wherein the first registration sensor operator receives the first control signal corresponding to the PWM signal, generates an analog output voltage according to the variable duty level, and outputs the analog output voltage to the first registration sensor as a first operation signal for operating the first registration sensor.

6. The apparatus according to claim 4, wherein the second registration sensor operator receives the second control signal corresponding to the PWM signal, generates an analog output voltage according to the variable duty level, and outputs the analog output voltage to the second registration sensor as a second operation signal for operating the second registration sensor.

7. A method of adjusting an amount of light emitted by registration sensors, the method comprising:
emitting and receiving light by at least one of a first registration sensor and a second registration sensor;
converting at least one of a first received light signal received by the first registration sensor and a second received light signal received by the second registration sensor;
outputting at least one of a first control signal for adjusting an amount of a first emitted light from the first registration sensor and a second control signal for adjusting an amount of a second emitted light from the second registration sensor; and
operating at least one of the first registration sensor in response to the first control signal and the second registration sensor in response to the second control signal.

8. The method according to claim 7, wherein the converting comprises:
amplifying at least one of the first received light signal and the second received light signal; and
converting at least one of the amplified first received light signal and the amplified second received light signal into digital signals.

9. The method according to claim 7, wherein the outputting comprises:
outputting at least one of the first control signal and the second control signal for adjusting at least one of the amount of the first emitted light and the amount of the second emitted light to correspond to the standard emitted light.

10. The method according to claim 7, wherein the outputting comprises:
outputting PWM signals comprising a variable duty level as the first control signal and the second control signal.

11. The method according to claim 10, wherein the operating further comprises:
receiving the first control signal corresponding to the PWM signal;
generating an analog output voltage according to the duty level; and
outputting the generated analog output voltage to the first registration sensor as a first operation signal for operating the first registration sensor.

12. The method according to claim 10, wherein the operating further comprises:
receiving the second control signal corresponding to the PWM signal;
generating an analog output voltage according to the duty level; and
outputting the generated analog output voltage to the second registration sensor as a second operation signal for operating the second registration sensor.

13. The method according to claim 7, further comprising:
operating at least one of the first registration sensor and the second registration sensor according to the first received light signal and the second received light signal, respectively, reflected from a moving transfer belt.

14. The method according to claim 7, further comprising:
operating at least one of the first registration sensor and the second registration sensor according to the first received light signal and the second received light signal, respectively, reflected from a stationary transfer belt.
